(19) United States
(12) Patent Application Publication
(10) Pub. No.: US 2025/0303709 A1
(43) Pub. Date: Oct. 2, 2025

(54) LIQUID EJECTION HEAD AND LIQUID EJECTION APPARATUS

(71) Applicant: CANON KABUSHIKI KAISHA, Tokyo (JP)

(72) Inventor: KEISUKE OKANOBU, Kanagawa (JP)

(21) Appl. No.: 19/096,907

(22) Filed: Apr. 1, 2025

(30) Foreign Application Priority Data
Apr. 2, 2024 (JP) 2024-059521

(51) Int. Cl. B41J 2/14; B41J 11/00

(52) U.S. Cl. CPC B41J 2/14; B41J 11/005

(57) ABSTRACT

The present disclosure provides a technique by which a printing medium whose leading edge portion is curled can be guided from a leading edge of the printing medium and an increase in weight can be reduced. The present disclosure is formed to include an element board ejecting a liquid; a support member supporting the element board, a protection cover covering and protecting the element board, wherein a gap is provided between the protection cover and the support member; a guide part provided near to the protection cover in the support member and regulating entry of the leading edge of the printing medium whose leading edge portion is curled into the gap and being capable of guiding the leading edge to a front surface side of the protection cover.

### BACKGROUND OF THE INVENTION

### Field of the Invention

The present disclosure relates to a liquid ejection head and a liquid ejection apparatus.

### Description of the Related Art

Japanese Patent Laid-Open No. 2022-168641 discloses a liquid ejection head which includes a cover member covering a flexible wiring substrate connected to a print element board while exposing an ejection port of the print element board supported by a support member to the outside. In this cover member, a guide part inclined in such a way to guide a printing medium whose leading edge portion is curved (curled) on an upstream side in a conveyance direction of the printing medium to a space between the liquid ejection head and a support portion (platen) from a leading edge of the printing medium during conveyance is formed.

However, in the technique disclosed in Japanese Patent Laid-Open No. 2022-168641, the cover member is formed so as to cover an entire support surface of the support member other than an area in which the ejection port is formed and to project from the support surface to the upstream side and a downstream side in the conveyance direction. This causes the size of the cover member to become larger, and the weight of the liquid ejection head also increases.

### SUMMARY OF THE INVENTION

The present disclosure is made in the light of the above problem and provides a technique by which a printing medium whose leading edge portion is curled can be guided from a leading edge of the printing medium and an increase in weight can be reduced.

A liquid ejection head includes an element board ejecting a liquid; a support member supporting the element board, a protection cover covering and protecting the element board, wherein a gap is provided between the protection cover and the support member, and a guide part provided near the protection cover in the support member, the guide part regulating entry of a leading edge of a printing medium whose leading edge portion is curled into the gap and being capable of guiding the leading edge to a front surface side of the protection cover.

According to the present disclosure, a printing medium whose leading edge portion is curled can be guided from a leading edge of the printing medium and an increase in weight can be reduced.

Further features of the present invention will become apparent from the following description of exemplary embodiments with reference to the attached drawings.

### BRIEF DESCRIPTION OF THE DRAWINGS

FIG. 1 is a schematic configuration view of a liquid ejection apparatus;

FIG. 2 is a perspective view of a liquid ejection head;

FIG. 3 is a schematic configuration view of an ejection unit;

FIGS. 4A to 4D are diagrams illustrating a support state of the ejection unit being supported by a support member;

FIGS. 5A to 5D are diagrams illustrating a guide part;

FIGS. 6A to 6D are diagrams illustrating a guide part according to another embodiment;

FIG. 7 is a schematic configuration view of a liquid ejection apparatus according to another embodiment;

FIGS. 8A to 8F are diagrams illustrating a guide part according to the other embodiment;

FIGS. 9A to 9D are diagrams illustrating a modification example of the guide part;

FIGS. 10A and 10B are diagrams illustrating a modification example of the guide part;

FIGS. 11A and 11B are diagrams illustrating a modification example of the guide part; and

FIGS. 12A and 12B are diagrams illustrating a modification example of the guide part.

### DESCRIPTION OF THE EMBODIMENTS

Hereinafter, with reference to the attached drawings, examples of embodiments of a liquid ejection head and a liquid ejection apparatus are explained. Incidentally, the following embodiments do not limit the present disclosure, and not all combinations of features explained in the present embodiments are indispensable for a solution to the present disclosure. Further, the positions, shapes, or the like of components described in the present embodiments are only examples and do not purport to limit the present disclosure to these only.

### First Embodiment

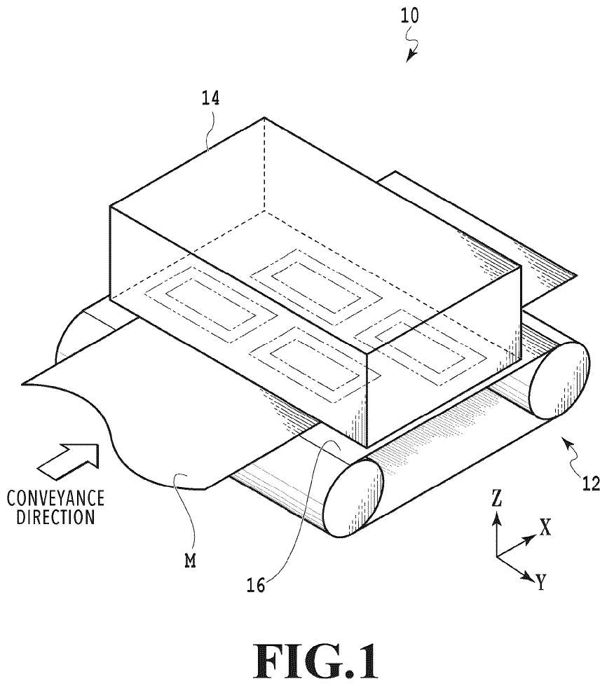

First, with reference to FIGS. 1 to 5D, a liquid ejection head according to a first embodiment is explained.

### Configuration of a Liquid Ejection Apparatus

A brief explanation about a configuration of a liquid ejection apparatus including the liquid ejection head according to the present embodiment is made. In the following explanation, a liquid ejection apparatus which includes a liquid ejection head ejecting ink as a liquid and which performs printing on a printing medium by ejecting the ink from the liquid ejection head is explained as an example. Incidentally, the liquid ejected from the liquid ejection head is not limited to the ink but includes a process liquid to apply a predetermined process to the ink ejected to the printing medium. Further, in the present embodiment, an explanation is made based on the premise that a conveyance direction of the printing medium is an X direction, a width direction of the printing medium orthogonal to the X direction is a Y direction, and a direction orthogonal to both X direction and Y direction is a Z direction. Furthermore, for an easy understanding, the explanation about the liquid ejection head is made by using a direction in a case where the liquid ejection head is mounted on the liquid ejection apparatus. In addition, in the following explanation, the “conveyance direction of the printing medium” is simply referred to as “conveyance direction” as appropriate.

FIG. 1 is a schematic configuration view of the liquid ejection apparatus. A liquid ejection apparatus 10 of FIG. 1 includes a conveyance part 12 conveying a printing medium M and an ejection head 14 ejecting ink to and performing printing on the printing medium M conveyed by the conveyance part 12. The conveyance part 12 is configured to convey the printing medium M in the X direction and includes a support part (platen) 16 supporting the printing medium M which is being conveyed. Accordingly, the printing medium M is conveyed to a space formed between the support part 16 and the liquid ejection head 14 by the conveyance part 12, and printing is performed by ejecting ink to the printing medium M from the liquid ejection head 14 in a state where the printing medium M is supported by the support part 16.

The liquid ejection apparatus 10 can continuously perform printing on the printing medium M with the liquid ejection head 14 while, for example, the conveyance part 12 conveys a plurality of printing media M continuously or intermittently. The printing medium M used in the liquid ejection apparatus 10 includes not only a cut sheet and a roll sheet or the like, but also what is capable of accepting ink such as cloth, a plastic film, a metal plate, glass, ceramics, wood, lather.

### Configuration of a Liquid Ejection Head

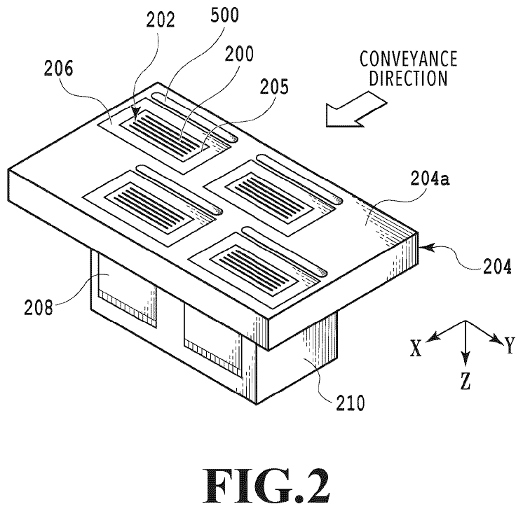

Next, a configuration of the liquid ejection head 14 is explained. FIG. 2 is a perspective view of the main part of the liquid ejection head 14 and a perspective view viewed from a bottom face side opposed to the support part 16 of the conveyance part 12. The liquid ejection head 14 includes a print element board 202 in which an ejection port 200 ejecting ink is formed and a support member 204 supporting the print element board 202. The print element board (hereinafter also referred to as “element board”) 202 is arranged in a surface 204a opposed to the support part 16 of the conveyance part 12 of the support member 204 so as to be capable of ejecting ink to the printing member M supported by the support part 16.

The liquid ejection head 14 includes a protection cover 206 covering and protecting the print element board 202 in a state where a predetermined area including an opening 205 to the ejection port 200 is exposed to the outside. Accordingly, a bottom face 14a of the liquid ejection head 14 includes the surface 204a of the support member 204, the protection cover 206, and the predetermined area including the ejection port 200 in the print element board 202. Further, the liquid ejection head 14 includes a flexible wiring substrate 208 to transmit electric power and a drive signal to the print element board 202 and a liquid supply part 210 to supply ink to the print element board 202 through the support member 204. The liquid supply part 210 includes various kinds of publically known functions such as an ink circulation function, a temperature adjustment function, and a filter function according to a property of ink to be used and a function of the liquid ejection head 14.

Ink is supplied to the liquid ejection head 14 from an ink tank (not illustrated) provided in the liquid ejection apparatus 10. This supplied ink is supplied to the print element board 202 through the liquid supply part 210 and the support member 204 in the liquid ejection head 14. Then, in the liquid ejection head 14, an energy generation element (not illustrated) in the print element board 202 is driven by the electric power and the drive signal transmitted through the flexible wiring substrate 208. Then, energy generated by driving the energy generation element causes ink to be ejected from the ejection port 200.

The liquid ejection head 14 has a line-type head configuration in which an ejection unit 220 including the print element board 202, the protection cover 206, and the flexible wiring substrate 208 is staggered in a range corresponding to the length of the width direction (Y direction) of the printing medium. In the present embodiment, the four ejection units 220 are staggered in the liquid ejection head 14, but the present disclosure is not limited to this. The number of ejection units 220 to be arranged in the liquid ejection head 14 are not limited to four, but may be one, two, three, or five or more. Further, the arrangement of the ejection unit 220 in the liquid ejection head 14 is not limited to staggered arrangement, but may be any of various kinds of publically known arrangements such as an in-line array.

### Configuration of an Ejection Unit

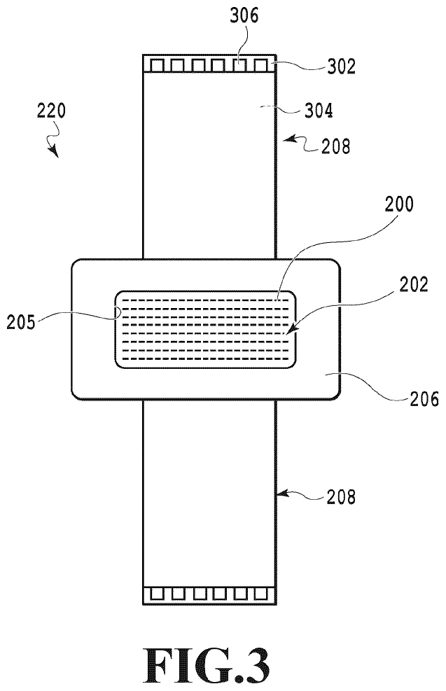

Next, a configuration of the ejection unit 220 is explained. FIG. 3 is a schematic configuration view of the ejection unit 220. As mentioned above, the ejection unit 220 includes the print element board 202, the protection cover 206, and the flexible wiring substrate 208. The print element board 202 includes therein an ink flow path (not illustrated) and the energy generation element (not illustrated) and is formed based on silicon, for example.

An ejection port forming member composed of, for example, photosensitive resin is provided in the print element board 202, and the ejection port 200 is formed in the ejection port forming member. Further, the protection cover 206 is mounted to the print element board 202 through an adhesive in a state where the predetermined area including the opening 205 to the ejection port 200 is exposed to the outside in order to protect part of a surface on which the ejection port 200 in the print element board 202 is formed and a periphery of the part. The protection cover 206 is made of metal, and the thickness of the protection cover 206 is, for example, from 0.1 to 0.5 mm. In the present embodiment, the protection cover 206 has a substantially rectangular shape and has a substantial plate shape extending over a XY planer surface.

As the energy generation element, various kinds of publically known elements such as a heating element and a piezoelectric element are used. Further, the energy generation element is electrically connected to the flexible wiring substrate 208, and while electric power is supplied from, for example, an energy source through the flexible wiring substrate 208 to the energy generation element, the drive signal is transmitted from a control part (not illustrated) or the like of the liquid ejection apparatus 10 to the energy generation element.

In the present embodiment, the flexible wiring substrate 208 is connected to a side of two opposing sides of the print element board 202. The flexible wiring substrate 208 is mainly composed of a base film 302, a cover film 304, and electric wiring 306. Resin with flexibility, for example, polyimide resin is used for the base film 302 and the cover film 304 to increase flexibility of handling. The electric wiring 306 is formed of copper foil or the like and is adhered by using an adhesive in such a way as to be sandwiched between the base film 302 and the cover film 304. In both ends in an extending direction of the flexible wiring substrate 208, part of the electric wiring 306 is exposed to the outside on the base film 302. The electric wring 306 which is exposed at one end of the flexible wiring substrate 208 is electrically connected to the print element board 202, and the electric wiring 306 which is exposed at the other end is electrically connected to an electric substrate or the like on a liquid ejection apparatus side.

### Ejection Unit in a Support Member

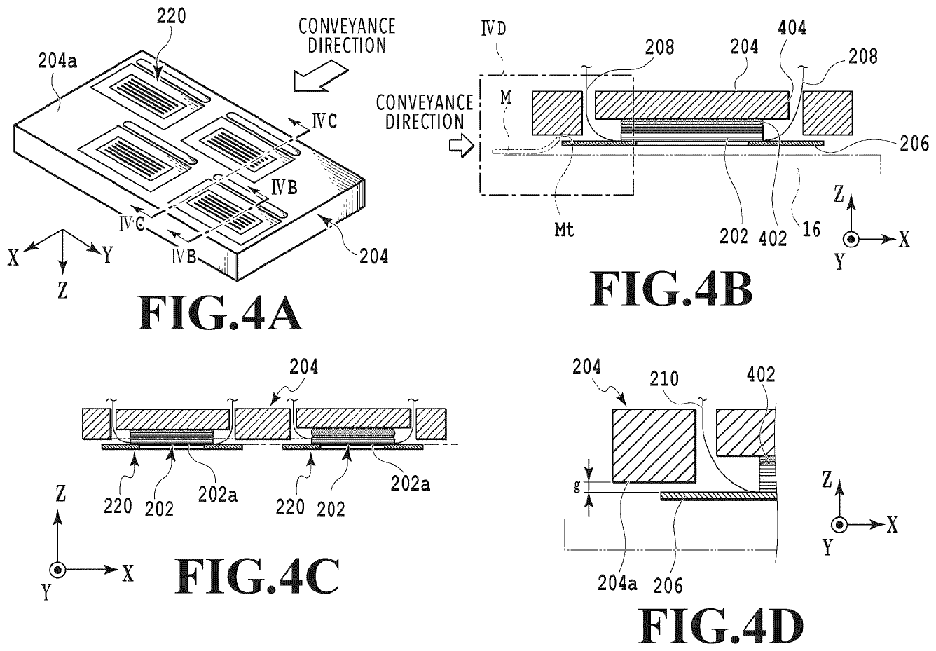

Next, the mounting of the ejection unit 220 in the support member 204 is explained. FIGS. 4A to 4D are diagrams illustrating a state where the ejection unit 220 is mounted to the support member 204. Incidentally, in FIGS. 4A to 4D, for an easy understanding, configurations other than the ejection unit 220 and the support member 204 are omitted and illustrated. FIG. 4A is a perspective view in which the support member 204 to which the ejection unit 220 is mounted is viewed from the surface 204a side. FIG. 4B is a cross-sectional view taken along line IVB-IVB of FIG. 4A. FIG. 4C is a cross-sectional view taken along line IVC-IVC of FIG. 4A. FIG. 4D is a magnified view of an inside of a IVD frame of FIG. 4B.

The ejection unit 220 is adhered to the support member 204 with high accuracy to deal with high-definition printing. The support member 204 supports the print element board 202 and includes a function as a flow path member supplying ink to the print element board 202. Accordingly, the print element board 202 in the ejection unit 220 is adhered to the support member 204 through an adhesive 402 in a state where the print element board 202 communicates with the support member 204 through a flow path. In a case where the print element board 202 is adhered to the support member 204, the print element board 202 to which the adhesive 402 is applied may be adhered to the support member 204, or the print element board 202 may be adhered to the support member 204 to which the adhesive 402 is applied.

It is preferable that the adhesive 402 is resistant to ink to be used, and in the present embodiment, thermosetting epoxy resin is used in such a way that the adhesive 402 is cured by heating at an actual temperature of 100° C. In a case where the liquid ejection head 14 changes in temperature because of heating in a case of the curing of the adhesive 402 or heating in a case of ink temperature adjustment or the like, an internal stress caused by the difference between the support member 204 and the print element board 202 in thermal expansion ratios arises, and the liquid ejection head 14 may be broken. Therefore, it is desirable to make the difference between the coefficient of linear expansion of the support member 204 and that of the print element board 202 small. In the present embodiment, alumina is used for the support member 204.

In a case where the print element board 202 is adhered to the support member 204, the flexible wiring substrate 208 in the ejection unit 220 is curved, inserted into a hole portion 404 provided in the support member 204, and inserted into the support member 204 (see FIG. 4B). The inserted flexible wiring substrate 208 is connected to an electric substrate (not illustrated) of the liquid ejection apparatus 10.

A plurality of ejection units 220 are adhered to the support member 204 in such a way as to align the position in a height direction (Z direction) of an ejection surface 202a in which an ejection opening 200 in the print element board 202 is formed (see FIG. 4C). Each ejection unit 220 (print element board 202) differs in size in the Z direction. Thus, in a case where the print element board 202 is adhered to the support member 204, floating mounting which absorbs the difference between the ejection units 220 in size in the Z direction is performed by making the crushing amount of the adhesive 402 different. In a case where floating mounting is performed, the position in the Z direction of the ejection surface 202a of each ejection unit 220 cannot be aligned in a case where the protection cover 206 contacts the support member 204. Thus, a gap g is provided between the support member 204 and the protection cover 206 (see FIG. 4D). Incidentally, the gap g is larger than the thickness of the printing medium M.

### Concern Which May Be Raised by the Protection Cover

In the configuration mentioned above, in the liquid ejection apparatus 10, printing is performed by ejecting ink from the liquid ejection head 14 to the printing medium M conveyed by the conveyance part 12.

As mentioned above, the gap g is provided between the support member 204 and the protection cover 206 in the surface 204a of the support member 204 forming a bottom surface 14a of the liquid ejection head 14. Thus, in a case where the leading edge portion of the printing medium M is curled and a leading edge Mt of the printing medium M is floated from the support part 16, the leading edge Mt enters the gap g (see FIG. 4B) during conveyance of the printing medium M, and then jamming arises because of further conveyance. Incidentally, in the present embodiment, the leading edge portion of the printing medium M represents a portion in a predetermined area from the leading edge Mt of the printing medium M, including the leading edge Mt of the printing medium. Further, the leading edge Mt of the printing medium M represents an end on a downstream side in a conveyance direction of the printing medium M.

In a case of the occurrence of jamming, it is necessary to stop printing which is being performed to remove the printing medium M. Further, a connection portion for connection between the print element board 202 and the flexible wiring substrate 208 may be damaged because of the contact of the entered leading edge Mt with the print element board 202 and an impact occurring in that case or the like.

### Guide Part

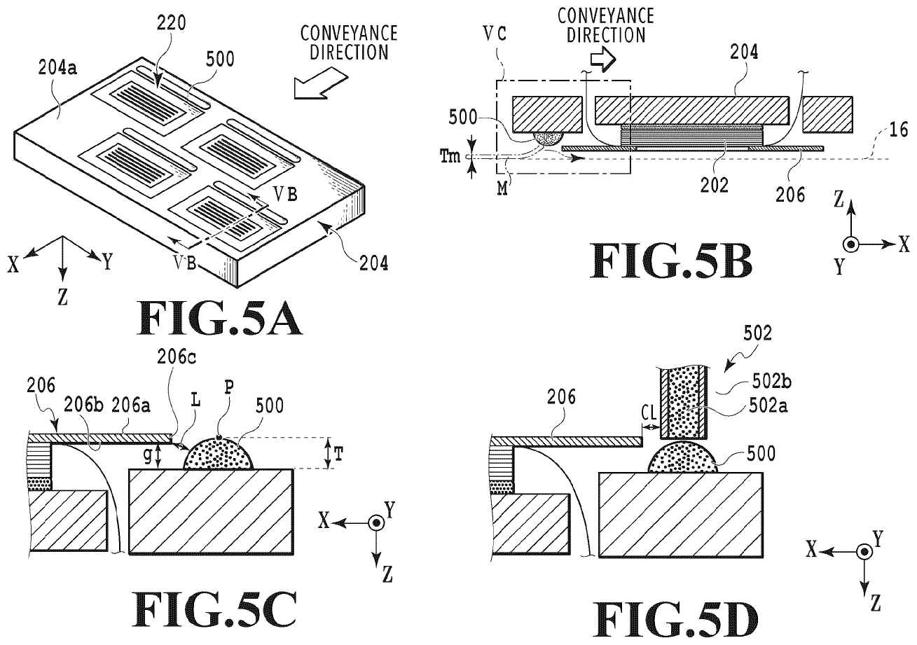

Then, in the present embodiment, a guide part 500 regulating entry of the leading edge Mt of the curled printing medium M into the gap g and being capable of guiding the leading edge Mt to a front surface 206a side of the protection cover 206 is provided to each ejection unit 220 (see FIG. 2 and FIG. 5A). In other words, in a case where the curled printing medium M is conveyed by the guide part 500, the present embodiment is made to regulate the entry of the leading edge Mt of the printing medium M to the gap g and guide the leading edge Mt to a space between the liquid ejection head 14 and the support part 16. FIGS. 5A to 5D are diagrams illustrating the guide part 500. FIG. 5A is a perspective view in which the support member 204 to which the ejection unit 220 is mounted is viewed from the surface 204a side. FIG. 5B is a cross-sectional view taken along line VB-VB of FIG. 5A. FIG. 5C is a magnified view of an inside of a VC frame of FIG. 5B. FIG. 5D is a diagram illustrating an example of a method for forming a guide part.

The guide part 500 is provided on the upstream side in the conveyance direction of each ejection unit 220 on the surface 204a of the support member 204. More specifically, the guide part 500 is provided in such a way as to be adjacent to the protection cover 206 on the upstream side in the conveyance direction relative to the protection cover 206. Further, the guide part 500 projects in a −Z direction (downward side in a vertical direction) (see FIG. 5B) and is formed in a liner shape substantially parallel to a long side of the protection cover 206 (see FIG. 5A) on the surface 204a.

The guide part 500 is, for example, formed by applying a resin material to the surface 204a of the support member 204 from an application needle 502 (see FIG. 5D) and then curing the resin material. The guide part 500 is formed in the same length as a side on the upstream side in the conveyance direction of the protection cover 206 or more in the Y direction. Incidentally, in a case where the ejection units 220 are adjacent to each other in the Y direction, the guide parts 500 corresponding to the protection covers 206 in these ejection units 220 may be joined together to form the guide parts 500.

As the value of the thickness T (length in the Z direction) of the guide part 500 is greater, an effect of regulating the entry of the leading edge Mt of the printing medium M and an effect of guiding the leading edge Mt improve, but it is necessary to narrow the distance between the printing medium M and the ejection surface 202a to perform high-definition printing. Thus, the thickness T (see FIG. 5C) is more preferably formed not to project in the −Z direction with respect to the front surface 206a of the protection cover 206. Specifically, the guide part 500 is more preferably formed higher than a rear surface 206b (adhesion surface to be adhered to the print element board 202) of the protection cover 206 which is mounted onto the print element board 202 and lower than the front surface 206a (see FIG. 5C) in the-Z direction. In other words, an apex P (see FIG. 5C) of the guide part 500 is preferably positioned between the front surface 206a of the protection cover 206 and the rear surface 206b of the protection cover 206 in the Z direction.

Thus, the thickness T of the guide part 500 needs to be formed with high accuracy. Accordingly, in a case where the guide part 500 is formed, the position in the Z direction of the front surface 206a of the protection cover 206 and the position in the Z direction of the surface 204a of the support member 204 are measured with a laser displacement gauge or the like. Then, the position in the Z direction of the application needle 502 is variable in accordance with a measurement result to apply a resin material with the application needle 502.

Further, the guide part 500 is formed so as to be separated from the protection cover 206 by a distance L such that the leading edge Mt of the curled printing medium M can be guided to the space between the liquid ejection head 14 and the support part 16 based on the acceptable degree of curling of the printing medium M (see FIG. 5C). Incidentally, it is preferable that the distance L (see FIG. 5C) between the protection cover 206 and the guide part 500 is narrowed to enhance a guide effect of the leading edge Mt. Specifically, the distance L is preferably smaller than the thickness Tm (see FIG. 5B) of the printing medium M.

### Formation of the Guide Part

The guide part 500 is shaped in such a way that the leading edge Mt of the printing medium M whose leading edge portion is curled can be guided to the space between the liquid ejection head 14 and the support part 16 during the conveyance of the printing medium M (see FIG. 5B). Specifically, the guide part 500 has a shape in which a surface on the upstream side in the conveyance direction (i.e., a surface formed on the upstream side in the conveyance direction from the apex P) be inclined in the −Z direction as the surface goes in the conveyance direction. Thus, in the present embodiment, the surface on the upstream side in the conveyance direction of the guide part 500 is an inclined surface which inclines from a support member 204 side to a protection cover 206 side as the surface approaches the protection cover 206.

In the present embodiment, in a case where the guide part 500 is formed so as to be separated from the protection cover 206 by the distance L, the position of an end 206c (see FIG. 5C) on the upstream side in the conveyance direction of the protection cover 206 is measured with image measurement equipment or the like. Then, in accordance with a measurement result obtained therewith, the position of the application needle 502 on an XY planar surface is determined. Then, while the application needle 502 is moved in the Y direction, the resin material is applied to the surface 204a of the support member 204 from the application needle 502, and the guide part 500 is formed by curing the applied resin material. Accordingly, in the present embodiment, the cross section in the conveyance direction of the guide part 500 forms in a dome shape (see FIG. 5D), and thereby the guide part 500 has a shape in which the surface on the upstream side in the conveyance direction is inclined in the −Z direction while curving as the surface goes in the conveyance direction.

Thus, first, the leading edge Mt of the printing medium M whose leading edge portion is curled abuts the guide part 500 because of conveyance. In this case, the leading edge Mt abuts the surface on the upstream side in the conveyance direction of the guide part 500. The shape of the surface on the upstream side in the conveyance direction of the guide part 500 is inclined to the −Z direction as the surface goes in the conveyance direction. Therefore, the leading edge Mt moves on the surface and is guided to the space between the liquid ejection head 14 and the support part 16 because of further conveyance of the printing medium M (see FIG. 5B).

Incidentally, in a case where the guide part 500 is formed by using the application needle 502, about 0.1 mm of a clearance CL between the protection cover 206 and the application needle 502 is required. This value of the clearance CL is set at a value to prevent the application needle 502 from contacting the protection cover 206 in view of the accuracy of an application apparatus for forming the guide part 500 by applying a resin material. Further, since a wall portion 502b (see FIG. 5D) forming a space portion 502a which the resin material passes through has a thickness in the application needle 502, a position to which the resin material is applied is separated from the protection cover 206 in the X direction. Furthermore, in order to form the thickness T of the guide part 500 so as not to project in the −Z direction with respect to the front surface 206a of the protection cover 206, it is difficult to perform an application by bringing the guide part 500 into contact with the protection cover 206.

It is possible to bring the guide part 500 into contact with the protection cover 206 by using a high-fluidity resin material as a resin material to form the guide part 500. However, in this case, the resin material spreads after the application of the resin material, and it is difficult to form a required thickness. Thus, the resin material to form the guide part 500 is a resin material with low fluidity and viscosity to the degree that the resin material can maintain the shape of the resin material from the completion of the application till the curing. Specifically, it is preferable that the viscosity of the resin material to form the guide part 500 is, for example, from 200 to 1500 Pa·s. In the present embodiment, the guide part 500 is formed by using a resin material with a viscosity of 300 Pa·s. Further, the guide part 500 preferably has hardness resistant to scraping in a case where the leading edge Mt of the printing medium M contacts the guide part 500. Accordingly. a resin material whose hardness after curing is, for example, hardness to the degree that the guide part 500 is less likely to be damaged even though the leading edge Mt of the printing medium M during the conveyance contacts the guide part 500 is used as the resin material to form the guide part 500. In the present embodiment, a thermosetting epoxy resin is used, and the one cured by heating at a real temperature of 100° C. is used.

### Operational Effect

As explained above, in the liquid ejection head 14, the protection cover 206 is independently provided in each print element board 202 supported by the support member 204 in such a way that the gap g is formed between the protection cover 206 and the surface 204a of the support member 204. Further, in the support member 204, on the upstream side in the conveyance direction of the protection cover 206, the guide part 500 which regulates the entry of the leading edge Mt of the curled printing media during the conveyance into the gap g and guides the leading edge Mt to the space between the liquid ejection head 14 and the support part 16 is provided.

Thus, in the liquid ejection head 14, a member protecting the print element board 202 and a member guiding the leading edge Mt of the curled printing medium to the space between the liquid ejection head 14 and the support part 16 can be made smaller than those of the technique disclosed in Patent Literature 1, and thereby the increase in weight of the liquid ejection head 14 can be reduced, and it is possible to reduce power consumption in a case of the movement of the liquid ejection head 14 such as a case of maintenance.

### Second Embodiment

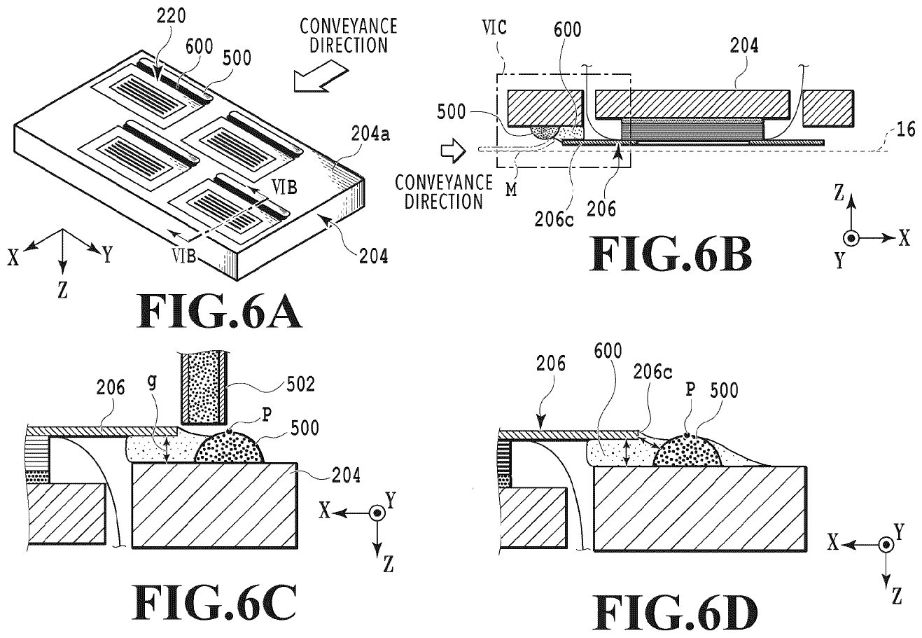

Next, with reference to FIGS. 6A to 6D, a liquid ejection head according to a second embodiment is explained. In the following explanation, the detailed descriptions of configurations which are identical or equivalent to those of the liquid ejection apparatus according to the first embodiment are omitted by using identical reference numerals to those used in the first embodiment.

The present embodiment is different from the first embodiment in that a gap between a protection cover 206 and a guide part 500 is filled with a filler to concatenate the protection cover 206 and the guide part 500. Hereinafter, the filler and a filling method thereof or the like are specifically explained.

### Filler

FIGS. 6A to 6D are diagrams illustrating a filler with which the gap between the protection cover 206 and the guide part 500 is filled. FIG. 6A is a perspective view in which a support member 204 to which an ejection unit 220 is mounted is viewed from a surface 204a side. FIG. 6B is a cross-sectional view taken along line VIB-VIB of FIG. 6A. FIG. 6C is a magnified view of an inside of a VIC frame of FIG. 6B and is a diagram illustrating an example of a filling method of a filler. FIG. 6D is a diagram illustrating an inclined portion formed with the filler.

The gap between the protection cover 206 and the guide part 500 is filled with a filler 600 in such a way that the protection cover 206 and the guide part 500 are concatenated. In this case, the filler 600 is formed in such a way that a ridgeline (i.e., a line connecting the protection cover 206 to the guide part 500) between the protection cover 206 and the guide part 500 is gentle (see FIG. 6C) in a cross section in a conveyance direction. For the filler 600, for example, the same resin material as is used in the guide part 500 is used, and fluidity of the resin material is made higher than that of the resin material used in a case where the guide part 500 is formed. The filler 600 is preferably, for example, set at a viscosity of 10 to 200 Pa·s in a case of filling.

In the present embodiment, a thermosetting epoxy resin with a viscosity of 40 Pa·s is used as the filler 600 and is cured by heating at a real temperature of 100° C. In regard to the filler 600, a resin material which is different from the resin material used in a case where the guide part 500 is formed may be used. Further, the filler 600 contains, for example, the same ingredients as those of the resin material used in a case where the guide part 500 is formed, and the viscosity may be adjusted by changing at least one of the diameter of a filler to be contained and the amount of the filler.

In this way, the protection cover 206 and the guide part 500 are connected by the ridgeline formed to be gentle by the filler 600. Thus, a leading edge Mt abutting a surface on an upstream side in the conveyance direction of the guide part 500 reaches the filler 600 after the leading edge Mt moves on the guide part 500 (see FIG. 6B). Then, the leading edge Mt reaches a front surface 206a of the protection cover 206 by moving on the filler 600 because of further conveyance of a printing medium M and thereby is guided to a space between the liquid ejection head 14 and the support part 16. In this way, in the present embodiment, the guide part 500 and the filler 600 function as configurations which can guide the leading edge Mt of the curled printing medium M to the surface 206 side of the protection cover 206.

The filler 600 has high fluidity and thus flows into a gap g between the protection cover 206 and a surface 204a of the support member 204 because of a capillary phenomenon in a case where the space between the protection cover 206 and the guide part 500 is filled with the filler 600. The protection cover 206 is supported by the surface 204a through the filler 600 as a result of the filling of the gap g with the filler 600, and proof stress in a case where an external force is applied to a portion near an end 206c on the upstream side in the conveyance direction of the protection cover 206 improves. Further, a minute droplet occurring in a case where ink is ejected from an ejection port 200 is less likely to adhere to an electric member such as a flexible wiring substrate 208 through the gap between the protection cover 206 and the surface 204a as a result of the filling of the gap g with the filler 600. Incidentally, in a case where a minute droplet adheres to an electrical member, an electrical trouble may arise.

The filling amount and the filling position of the filler 600 are determined according to position information about the positions of the protection cover 206 and the support member 204 in the Z direction and position information about the position of the end 206c on the upstream side in the conveyance direction of the protection cover 206 on the XY planar surface in a case of the application to the guide part 500. Incidentally, these pieces of information may be obtained in a case where the filling of the filler 600 is performed. Further, in a case where the filling of the filler 600 is performed, the application needle 502 may be positioned by using a jig or the like. The gap between the protection cover 206 and the guide part 500 is filled with the filler 600 without bringing the filler 600 into contact with the front surface 206a of the protection cover 206.

In the aforementioned explanation, the gap between the protection cover 206 and the guide part 500 is filled with the filler 600, but the present disclosure is not limited to this. Further, an inclined portion 602 may be formed in such a way that the surface 204a of the support member 204 and a portion near an apex P of the guide part 500 are gently connected on the upstream side in the conveyance direction of the guide part 500 (see FIG. 6D). In a case where the inclined portion 602 is formed, a resin material is used for the filler 600, for example. This causes the leading edge Mt to be smoothly guided to the guide part 500, and jamming is much less likely to occur.

### Operational Effect

As explained above, the gap between the protection cover 206 and the guide part 500 is filled with the filler in such a way as to smoothly connect the front surface 206a of the protection cover 206 to the portion near the apex P of the guide 500. Thus, in addition to the operational effect of the first embodiment, the movement of the leading edge Mt from the guide part 500 to the front surface 206a of the protection cover 206 can be smoothly performed, and an operational effect that jamming is less likely to occur in a case of the movement from the guide part 500 to the protection cover 206 is exhibited.

Further, the inclined portion 602 smoothly connecting the portion near the apex P of the guide 500 to the surface 204a of the support member 204 is formed on the upstream in the conveyance direction of the guide part 500. The movement of the leading edge Mt from the surface 204a to the guide part 500 can be smoothly performed thereby, and jamming is less likely to occur in a case of the movement of the leading edge Mt from the surface 204a to the guide part 500.

### Third Embodiment

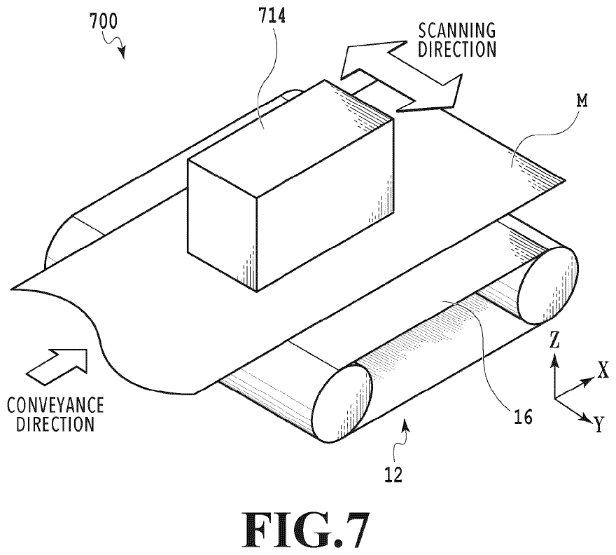

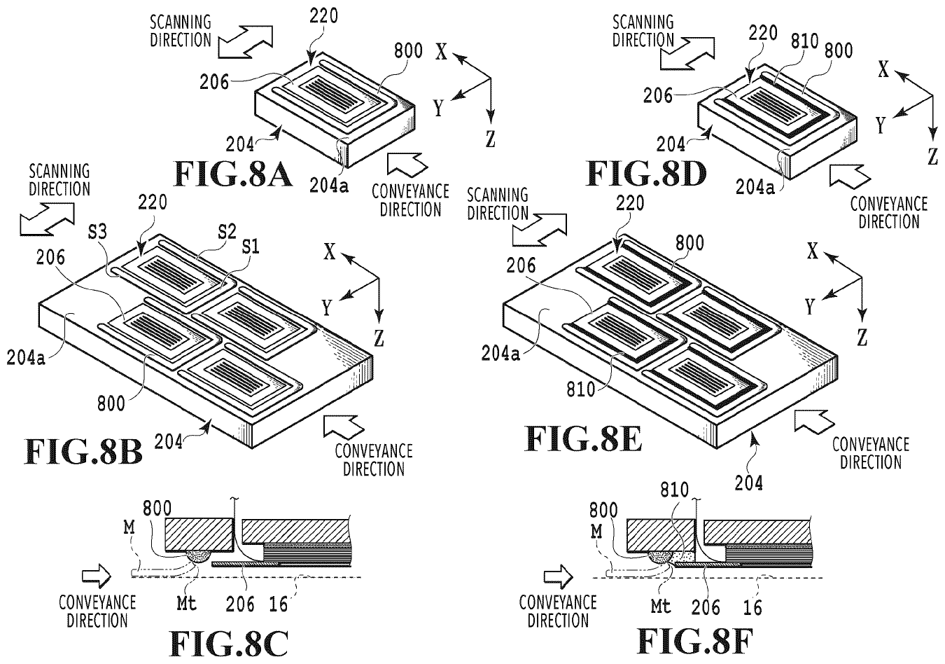

Next, with reference to FIGS. 7 to 8F, a liquid ejection head in accordance with a third embodiment is explained. In the following explanation, the detailed descriptions of configurations identical or equivalent to those of the liquid ejection apparatus according to the first embodiment are omitted by using identical reference numerals to those used in the first embodiment.

While the liquid ejection head according to the first embodiment has a configuration ready for a line-type liquid ejection apparatus, the liquid ejection head according to the second embodiment is configured to be ready for a serial scan liquid ejection apparatus. The liquid ejection head according to the present embodiment is different from the liquid ejection head of the first embodiment in that a guide part is provided near three sides of the upstream side in the conveyance direction of a protection cover 206 and one side and the other side in a scanning direction of the liquid ejection head.

### Configuration of a Liquid Ejection Apparatus

FIG. 7 is a schematic configuration diagram of a liquid ejection apparatus including the liquid ejection head according to the present embodiment. A liquid ejection apparatus 700 of FIG. 7 includes a conveyance part 12 which conveys a printing medium M and a liquid ejection head 714 which performs printing on the printing medium M conveyed by the conveyance part 12 while performing scanning in a direction intersecting (in the present embodiment, orthogonal to) with a direction in which the printing medium M is conveyed by the conveyance part 12. In the liquid ejection head 714, an ejection port array formed by arraying a plurality of ejection ports 200 in a print element board 202 is installed in such a way as to intersect with a scanning direction (Y direction) of the liquid ejection head 714. Hereinafter, the “scanning direction of the liquid ejection head 714” is simply referred to as “scanning direction” as appropriate.

In the liquid ejection apparatus 700, a printing operation in which ink is ejected from the liquid ejection head 714 while the liquid ejection head 714 moves in the scanning direction is performed on the printing medium M in a printing position. Then, a conveyance operation in which the printing medium M is conveyed by the conveyance part 12 by a predetermined amount is performed, and then a printing operation is performed again. In this way, in the liquid ejection apparatus 700, printing is performed on a printing medium by alternately and repeatedly performing the printing operation and the conveyance operation.

### Configuration of a Liquid Ejection Head

Next, a configuration of the liquid ejection head 714 is explained. FIGS. 8A to 8F are schematic configuration diagrams of the main part of the liquid ejection head 714. FIG. 8A is a diagram illustrating an example including one ejection unit 220. FIG. 8B is a diagram illustrating an example including four ejection units 220. FIG. 8C is a cross-sectional view of a portion near a guide part 800 of FIGS. 8A and 8B. FIG. 8D is a modification example of FIG. 8A. FIG. 8E is a modification example of FIG. 8B. FIG. 8F is a cross-sectional view of the portion near the guide part 800 of FIGS. 8D and 8E. Incidentally, arrows in FIGS. 8C and 8F denote relative movement directions (i.e., conveyance direction and scanning direction) of the printing medium M with respect to the liquid ejection head 714. In the following explanation, a difference between the liquid ejection head 714 and the liquid ejection head 14 is explained, and an explanation about the same configurations is omitted.

The liquid ejection head 714, for example, may have a configuration including one ejection unit 220 (see FIG. 8A) and, for example, may be configured in such a way that four ejection units 220 are staggered in such a way as to extend in the conveyance direction (see FIG. 8B). Incidentally, the number of ejections units 220 and the positions thereof in the liquid ejection head 714 are not limited to these. In the liquid ejection head 714, a guide part 800 formed by concatenating three sides of the upstream side in the conveyance direction, one side in the scanning direction, and the other side in the scanning direction of the protection cover 206 so as to surround the guide part 800 is formed in the surface 204a of the support member 204. In other words, in a case where the four ejection units are included, in the liquid ejection head 714, the guide part 800 formed by concatenating the above three sides so as to surround the guide part 800 is formed in the protection cover 206 in each ejection unit 220.

Incidentally, in the guide part 800, a cross section in the conveyance direction has a dome shape in an area S1 positioned on the upstream side in the conveyance direction, and a cross section in the scanning direction has a dome shape in an area S2 and an area S3 respectively positioned on one side and the other side in the scanning direction. Further, the guide part 800 is formed so as to be separated from each side of the protection cover 206 by a distance L. As mentioned above, the distance L is smaller than the thickness Tm of the printing medium M.

In this case, in a case where the leading edge portion of the printing medium M is curled, the leading edge Mt of the printing medium M abuts the guide part 800 because of the conveyance performed by the conveyance part 12 and scanning performed by the liquid ejection head 714. In this case, a surface of the guide part 800 which the leading edge Mt abuts is gradually inclined in the −Z direction to a downstream side in a relative movement direction (i.e., protection cover 206 side) (see FIG. 8C). Thus, the leading edge Mt moves on the guide part 800 and is guided to a space between the liquid ejection head 14 and the support part 16 by further conveyance or scanning. Incidentally, in the present embodiment, the leading edge Mt of the printing medium M includes an end on the downstream side in the conveyance direction of the printing medium M and one end and the other end of in a width direction (scanning direction) of the printing medium M.

In the ejection head 714, a gap between the protection cover 206 and the guide part 800 may be filled with a filler 810 as in the second embodiment (see FIGS. 8D to 8F). In this case, the protection cover 206 and the guide part 800 are smoothly concatenated with the filler 810. In a case where the leading edge portion of the printing medium M is curled, the leading edge Mt of the printing medium M abuts the guide part 800 by the conveyance performed by the conveyance part 12 and the scanning performed by the liquid ejection head 714. After that, because of further conveyance or scanning, the leading edge Mt moves on the guide part 800 and the filler 810 and is guided to the space between the liquid ejection head 714 and the support part 16 (see FIG. 8F).

### Operational Effect

As explained above, in the liquid ejection head 714, the guide part 800 which can guide the leading edge Mt of the printing medium M whose leading edge portion is curled to the space between the guide part 800 and the support part 16 is provided to the upstream side in the conveyance direction of the protection cover 206, the one side in the scanning direction, and the other side in the scanning direction. The same operational effect as that of the first embodiment can be obtained thereby in the liquid ejection head 714.

### Other Embodiments

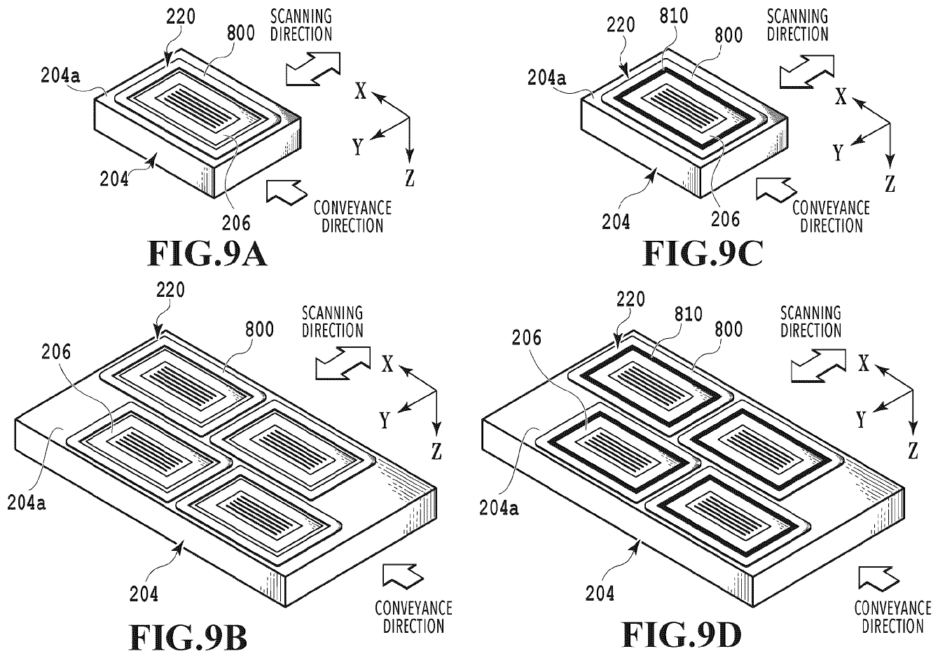

Incidentally, the above embodiments may be modified as shown in (1) to (6) below.
(1) In the third embodiment, the guide part 800 is formed by concatenating the three sides of the upstream side in the conveyance direction, the one side in the scanning direction, and the other side in the scanning direction of the protection cover 206 so as to surround the guide part 800, but the present disclosure is not limited to this. For example, the guide part 800 may be formed by concatenating four sides so as to surround the guide part 800: the upstream side in the conveyance direction, the one side in the scanning direction, the other side in the scanning direction, and a downstream side in the conveyance direction of the protection cover 206 (see FIGS. 9A and 9B).

In this case, in a case where the gap between the protection cover 206 and the guide part 800 is filled with the filler 810 (see FIGS. 9C and 9D), the amount of squeezed-out portions of the filler 810 can be reduced. Further, in this case, the gap g between the protection cover 206 and the surface 204a around the print element board 202 is sealed with the filler 810. Thus, stress proof in a case where an external force is applied to the print element board 202 improves. Furthermore, a minute droplet occurring in a case where ink is ejected from the ejection port 200 is less likely to adhere to an electric member such as the flexible wiring substrate 208.
(2) In the above embodiments, the shape of the cross section of the guide part 500 is a dome shape, but the present disclosure is not limited to this. The shape of the cross section of the guide part 500 may be any shape as long as the shape is a shape which can guide the leading edge Mt of the curled printing medium M to the space between the liquid ejection head 14 and the support part 16 during the conveyance. Further, in the above embodiments, the shape of the cross section of the guide part 800 is a dome shape, but the present disclosure is not limited to this. The shape of the cross section of the guide part 800 may be any shape as long as the shape is a shape which can guide the leading edge Mt of the curled printing medium M to the space between the liquid ejection head 14 and the support part 16 in a case of the conveyance and the scanning.

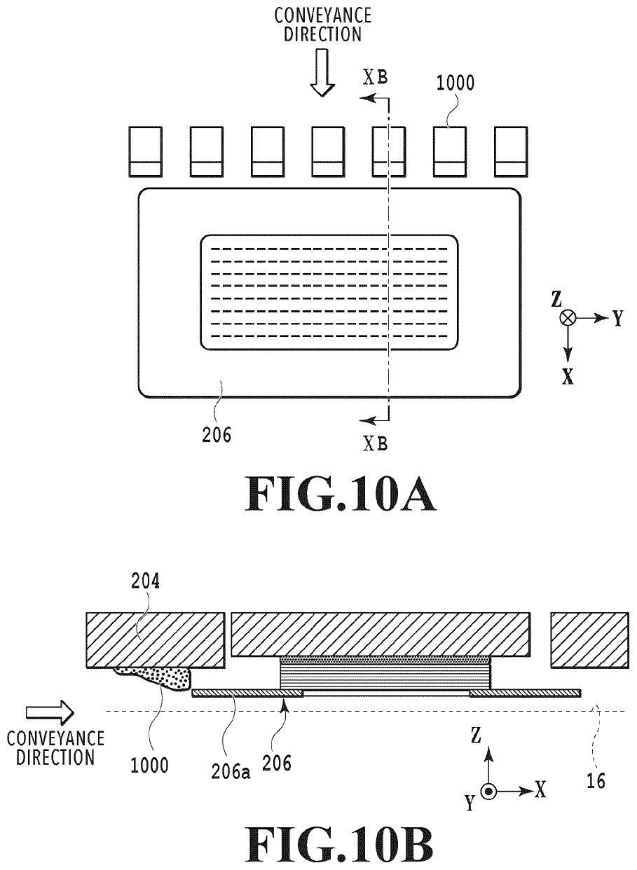

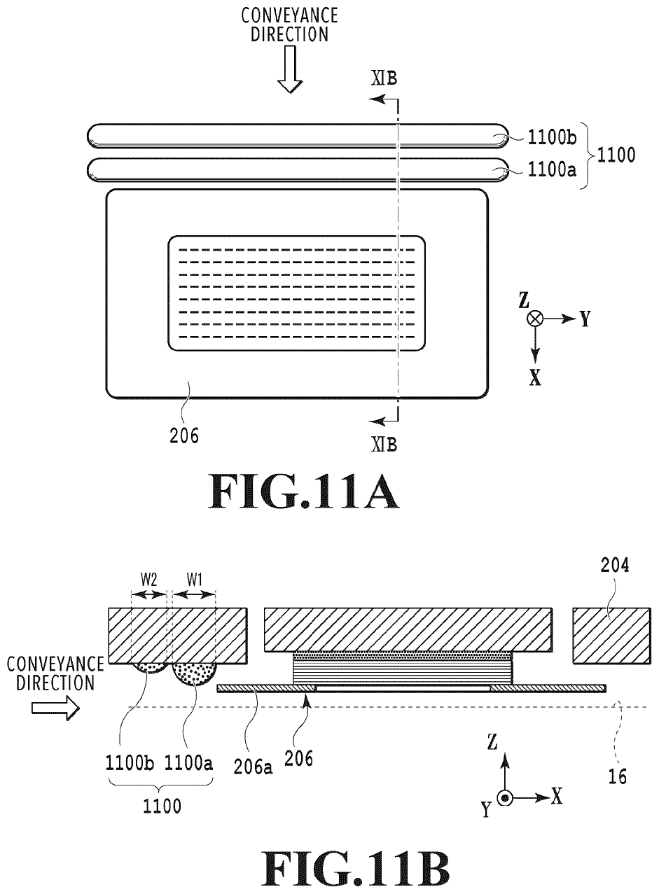

With reference to FIGS. 10A and 10B, an example of a shape other than the dome shape is explained by taking the guide part 500 as an example. FIGS. 10A and 10B are diagrams illustrating a guide part 1000 which is a modification example of the guide part 500. FIG. 10A is a planar view of the ejection unit 220 and the guide part 1000 mounted to the support member 204. FIG. 10B is a cross-sectional view taken along line XB-XB of FIG. 10A. The guide part 1000 is formed in such a way as to be gradually inclined in the −Z direction as the guide part 1000 goes in the conveyance direction. Incidentally, the guide part 1000 is formed so as not to project in the −Z direction with respect to the front surface 206a of the protection cover 206. Further, the guide part 1000 is formed so as to be separated from the protection cover 206 in the conveyance direction (X direction) by the distance L. An illustration is omitted, but a space between the guide part 1000 and the protection cover 206 may be filled with a filler 600 as in the second embodiment.
(3) In the above embodiments, the guide parts 500 and 800 have configurations formed of one line, but the present disclosure is not limited to these. The guide parts 500 and 800 may be formed of a plurality of lines. Hereinafter, with reference to FIGS. 11A and 11B, an example of a guide part formed of the plurality of lines is explained by taking the guide part 500 as an example. FIGS. 11A and 11B are diagrams illustrating an example of a guide part 1100 formed of a plurality of line shapes. FIG. 11A is a planar view of the ejection unit 220 and the guide part 1100 which are mounted to a support member. FIG. 11B is a cross-sectional view taken along line XIB-XIB of FIG. 11A.

The guide part 1100 includes a first line 1100a separated by the distance L from the end 206C of the protection cover 206 on the upstream side in the conveyance direction of the protection cover 206. Further, the guide part 1100 includes a second line 1100 which is separated from the first line 1100a by a predetermined distance and whose thickness (length in the Z direction) is smaller than that of the first line 1100a on the upstream side in the conveyance direction of the first line 1100a.

Incidentally, the predetermined distance may be equal to, for example, the distance L between the first line 1100a and the protection cover 206 or may be shorter than the distance L. Further, the first line has the same configuration as that of the guide part 500. Further, the width W2 (length in the conveyance direction) of the second line 1100b may be equal to the width W1 of the first line 1100a or may be shorter than the width W1. In other words, in the guide part, a line positioned on an upstream side in a relative movement direction of a printing medium with respect to a liquid ejection head is formed smaller than a line positioned on a downstream side in the movement direction of the line.

In this way, since a smaller line is formed on the upstream side in a direction (relative movement direction) in a case where the printing medium M relatively moves with respect to the liquid ejection head, the leading edge Mt of the curled printing medium M is smoothly guided to the space between the liquid ejection head 14 and the support part 16, and thereby a suppressive effect on the occurrence of jamming improves.

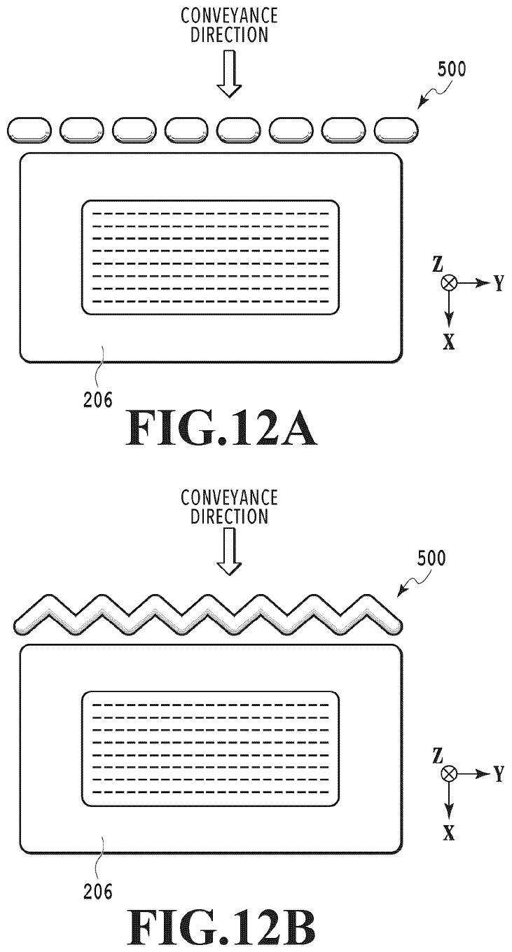

Incidentally, in the above explanation, the guide part 1100 is formed out of two lines, but the present disclosure is not limited to this. The guide part 1100 may be formed out of three or more lines. Further, in the guide part 1100, at least one of the gap between the first line 1100a and the protection cover 206 and the gap between the first line 1100a and the second line 1100b may be filled with the filler 600.
(4) In the above embodiments, the guide parts 500 and 800 are formed in a continuous liner line shape substantially parallel to opposing sides of the protection cover 206, but the present disclosure is not limited to this. The guide part 500 (800) may, for example, have a shape (see FIG. 12A) which is broken at predetermined intervals or may have a shape which is formed in a predetermined width in the conveyance direction (and scanning direction) and is curved or bent (see FIG. 12B). Incidentally, in FIGS. 12A and 12B, a shape in which the guide 500 is given as an example is illustrated as an example of a modification example, and the modification example is applicable to the guide part 800 likewise. In a case where the shape curves or bends in a predetermined width in the conveyance direction (and scanning direction), the guide part and the protection cover 206 may be concatenated with the filler 600 in a position in which the guide part is close to the protection cover 206 in the conveyance direction (and scanning direction).
(5) In the above embodiments, the guide part 500 (800) is formed so as to be separated from the protection cover 206 by the distance L, but the present disclosure is not limited to this. The guide part 500 (800) may be formed in such a way as to contact the protection cover 206 without using a filler, for example. In order to form the guide part 500 (800) in such a way as to contact the protection cover 206, for example, a resin material to form the guide part 500 (800) is applied to a position which can contact the protection cover 206 before the ejection unit 220 is mounted to the support member 204, and then the ejection unit 220 is mounted to the support member 204, and the resin material is cured in a state where the resin material prior to curing is in contact with the protection cover 206.
(6) The above embodiments and the embodiments shown in (1) to (5) above of various kinds may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-059521, filed Apr. 2, 2024, which is hereby incorporated by reference wherein in its entirety.

What is claimed is:

1. A liquid ejection head comprising:
an element board ejecting a liquid;
a support member supporting the element board;
a protection cover covering and protecting the element board, wherein a gap is provided between the protection cover and the support member; and
a guide part provided near the protection cover in the support member, the guide part regulating entry of a leading edge of a printing medium whose leading edge portion is curled into the gap and being capable of guiding the leading edge to a front surface side of the protection cover.

2. The liquid ejection head according to claim 1, wherein
the guide part is provided so as to be adjacent to an upstream side in a conveyance direction of the printing medium with respect to the protection cover.

3. The liquid ejection head according to claim 2, wherein
the guide part is further provided so as to be adjacent to one side in a scanning direction and the other side in the scanning direction of the liquid ejection head with respect to the protection cover.

4. The liquid ejection head according to claim 3, wherein
the guide part is further provided so as to be adjacent to a downstream side in the conveyance direction with respect to the protection cover.

5. The liquid ejection head according to claim 1, wherein
the guide part is formed so as to be separated from the protection cover by a predetermined distance.

6. The liquid ejection head according to claim 5, wherein
the predetermined distance is smaller than a thickness of the printing medium.

7. The liquid ejection head according to claim 1, wherein
the guide part is formed so as to be in contact with the protection cover.

8. The liquid ejection head according to claim 1, wherein
the guide part comprises an inclined surface which inclines from a side of the support member to a side of the protection cover as the inclined surface approaches the protection cover.

9. The liquid ejection head according to claim 1, wherein
the guide part is formed so as not to project in a vertical direction with respect to the protection cover.

10. The liquid ejection head according to claim 1, wherein
the guide part is formed in a length equal to a length of an adjacent side of the protection cover or more.

11. The liquid ejection head according to claim 1, wherein
the gap is larger than a thickness of the printing medium.

12. The liquid ejection head according to claim 1, wherein
the guide part is continuously formed.

13. The liquid ejection head according to claim 1, wherein
the guide part is formed so as to be broken at a predetermined interval.

14. The liquid ejection head according to claim 1, wherein
the guide part is formed in a predetermined width and is formed so as to be curved or bent.

15. The liquid ejection head according to claim 1, wherein
the guide part is formed of a plurality of lines.

16. The liquid ejection head according to claim 15, wherein
in the guide part, a line positioned on an upstream side in a relative movement direction of the printing medium with respect to the liquid ejection head is formed smaller than a line positioned on the downstream side in the relative movement direction of the line.

17. A liquid ejection apparatus comprising:
a conveyance unit configured to convey a printing medium; and
a liquid ejection head formed so as to be capable of ejecting a liquid to an area corresponding to the printing medium in a width direction of the printing medium intersecting with a conveyance direction of the conveyance unit,
wherein the liquid ejection head comprises:
an element board ejecting a liquid;
a support member supporting the element board;
a protection cover covering and protecting the element board, wherein a gap is provided between the protection cover and the support member; and
a guide part provided near the protection cover in the support member, the guide part regulating entry of a leading edge of the printing medium whose leading edge portion is curled into the gap and being capable of guiding the leading edge to a front surface side of the protection cover;
wherein the guide part is provided so as to be adjacent to an upstream side in a conveyance direction of the printing medium with respect to the protection cover.

18. The liquid ejection apparatus according to claim 17, wherein
the guide part is further provided so as to be adjacent to one side in a scanning direction and the other side in the scanning direction of the liquid ejection head with respect to the protection cover.

19. The liquid ejection apparatus according to claim 18, wherein
the guide part is further provided so as to be adjacent to a downstream side in the conveyance direction with respect to the protection cover.
